(19) United States
(12) Patent Application Publication
(10) Pub. No.: US 2024/0333830 A1
(43) Pub. Date: Oct. 3, 2024

(54) MOBILE VIDEO CONFERENCING INTERFACE WITH CHAT CHANNEL AND FILE SHARING INTEGRATION

(71) Applicant: WORKSTORM.COM LLC, Chicago, IL (US)

(72) Inventors: Raj FERNANDO, Chicago, IL (US); Anatoliy YUDOVICH, Riverwoods, IL (US); Michael BARRY, Chicago, IL (US); Andrew CHRISTENSEN, Chicago, IL (US); Nicholas STECH, Chicago, IL (US)

(73) Assignee: WORKSTORM.COM LLC, Chicago, IL (US)

(21) Appl. No.: 18/622,712

(22) Filed: Mar. 29, 2024

Related U.S. Application Data
(60) Provisional application No. 63/456,186, filed on Mar. 31, 2023.

(51) Int. Cl. H04M 1/7243; G06F 3/0482; G06F 3/0484; H04L 51/046; H04L 65/403

(52) U.S. Cl. CPC H04M 1/7243; G06F 3/0482; G06F 3/0484; H04L 51/046; H04L 65/403

(57) ABSTRACT

Disclosed herein are system, method, and computer program product embodiments for providing a mobile video conferencing interface with chat channel selection and file sharing integration. The video conferencing application also integrates with a chat messaging platform to provide streamlined access to multiple chat panels while still on a mobile device. A mobile device graphical user interface may include a video conference stream and access to a list of chat channels. The interface may allow a user to select a particular chat channel. In response to the selection, a messaging system retrieves messages corresponding to the chat channel and generates a chat panel. The chat panel is displayed along with the video conference stream. This interface is well-suited for mobile screens. The interface also allows for file sharing between chat panels displayed on the mobile device.

### BACKGROUND

### Field

This field is generally related to a mobile video conferencing application that integrates with a messaging system to provide chat channel selection and file sharing.

### Related Art

As the demands of the workplace evolve, organizations often find themselves relying more on hybrid communications. For example, the use of video conferencing has increased to facilitate meetings. When attending a video conference, however, users may find that written communication is cumbersome. For example, navigating to different screens to view different information becomes complicated when participating in a video conference. This problem is especially pronounced when accessing a video conference using a mobile device. It is equally as difficult to share files with the other members of the video conference. These difficulties may lead to cumbersome and inefficient communications and may negatively impact workplace productivity.

### BRIEF SUMMARY

Disclosed herein are system, apparatus, device, method and/or computer program product embodiments, and/or combinations and sub-combinations thereof, for mobile video conferencing application that integrates with a messaging system to provide chat channel selection and file sharing.

In some embodiments, a messaging system provides a graphical user interface (GUI) for mobile devices that allows for the viewing and selection of chat channels while the user is simultaneously participating in a video conference. The GUI is particularly suited for the screen size of mobile devices to streamline navigation and communications with different chat channels.

For example, the user may access the messaging system via a mobile device. The messaging system receives log-in information and provides the mobile device with a video conference interface. The GUI presented to the mobile device includes the video conference interface. This video conference interface includes a video conference stream. For example, this may include live video and/or audio with other participants of the video conference. Similarly, the mobile device using the GUI provides video and audio from the user to the messaging system for transmission to the other participants of the video conference.

The GUI may also facilitate chat, messaging, or textual communications for the video conference. The chat, messaging, or textual communications may be considered as a chat channel. For example, the messaging system creates and/or facilitates a chat channel for the video conference. Similarly, the messaging system may also track several chat channels for a particular user. These may be other messaging channels and/or may be with other participants.

When participating in a video conference, the user may wish to access the other chat channels. For example, the user may wish to review information from the other chat channels or send a message to another chat channel. Similarly, a user may wish to identify a file and/or send a file between chat channels while still participating on the video conference. To accommodate this functionality while addressing potential size constraints of a mobile device's small screen, the messaging system provides a mobile device GUI that facilitates navigation between chat channels. The mobile device GUI also facilitates the upload, searching for, and sharing of files while on a mobile device as well. Aspects of the mobile device GUI are reflected in the figures below.

By providing the mobile device GUI, the messaging system may provide efficient communications and navigational tools for a user accessing a video conference on a mobile device. The mobile device GUI may provide a streamlined way to access multiple channels while participating on a video conference and may allow for the searching and sharing of files between these chat channels.

### BRIEF DESCRIPTION OF THE DRAWINGS

The accompanying drawings are incorporated herein and form a part of the specification.

FIG. 1 depicts a block diagram of a messaging environment, according to some embodiments.

FIG. 2A depicts a block diagram of a graphical user interface (GUI) displaying a video conference stream and a list of chat channels, according to some embodiments.

FIG. 2B depicts a block diagram of a graphical user interface (GUI) displaying a minimized video conference stream and a list of chat channels, according to some embodiments.

FIG. 3A depicts a block diagram of a graphical user interface (GUI) displaying a video conference stream and a chat panel, according to some embodiments.

FIG. 3B depicts a block diagram of a graphical user interface (GUI) displaying a minimized video conference stream and a chat panel, according to some embodiments.

FIG. 4 depicts a block diagram of a graphical user interface (GUI) displaying a video conference stream and text entry object in a chat panel, according to some embodiments.

FIG. 5 depicts a block diagram of a graphical user interface (GUI) displaying a video conference stream and a file upload interface, according to some embodiments.

FIG. 6 depicts a block diagram of a graphical user interface (GUI) displaying a video conference stream and a file searching interface, according to some embodiments.

FIG. 7A depicts a block diagram of a graphical user interface (GUI) displaying a video conference stream and a chat panel with a vertical orientation, according to some embodiments.

FIG. 7B depicts a block diagram of a graphical user interface (GUI) displaying a video conference stream, a chat panel, and a list of chat channels with a horizontal orientation, according to some embodiments.

FIG. 8 depicts a block diagram of a graphical user interface (GUI) displaying a full-screen video conference stream, according to some embodiments.

FIG. 9 depicts a flowchart illustrating a method for simultaneously providing a video conference stream and a chat panel, according to some embodiments.

FIG. 10 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a mobile video conferencing interface with chat channel selection and file sharing integration. The video conferencing application also integrates with a chat messaging platform to provide streamlined access to multiple chat panels while still on a mobile device. A mobile device graphical user interface may include a video conference stream and access to a list of chat channels. The interface may allow a user to select a particular chat channel. In response to the selection, a messaging system retrieves messages corresponding to the chat channel and generates a chat panel. The chat panel is displayed along with the video conference stream. This interface is well-suited for mobile screens. The interface also allows for file sharing between chat panels displayed on the mobile device.

Various embodiments of these features will now be discussed with respect to the corresponding figures.

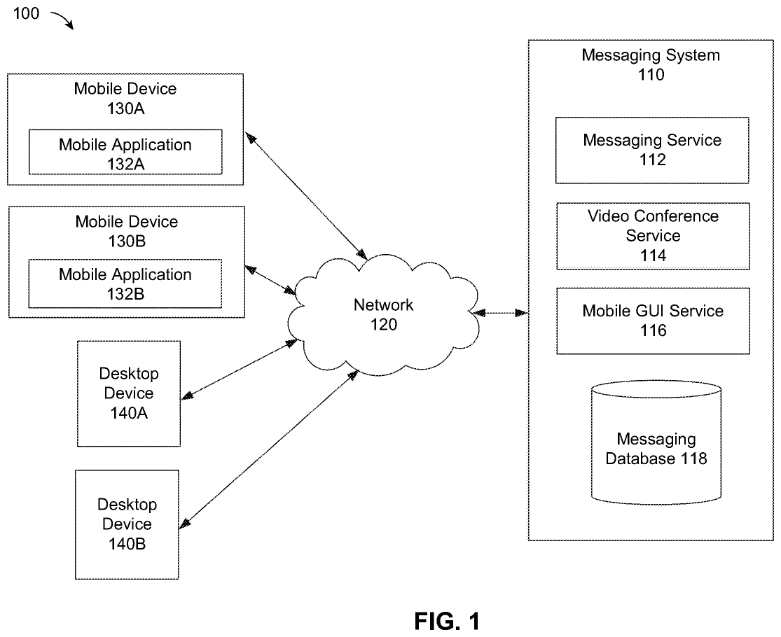

FIG. 1 depicts a block diagram of a messaging environment 100, according to some embodiments. Messaging environment 100 includes messaging system 110, network 120, mobile devices 130A, 130B, and/or desktop devices 140A, 140B. Messaging system 110 may include messaging service 112, video conference service 114, mobile GUI service 116, and/or messaging database 118. Mobile devices 130A, 130B may include respective mobile applications 132A, 132B.

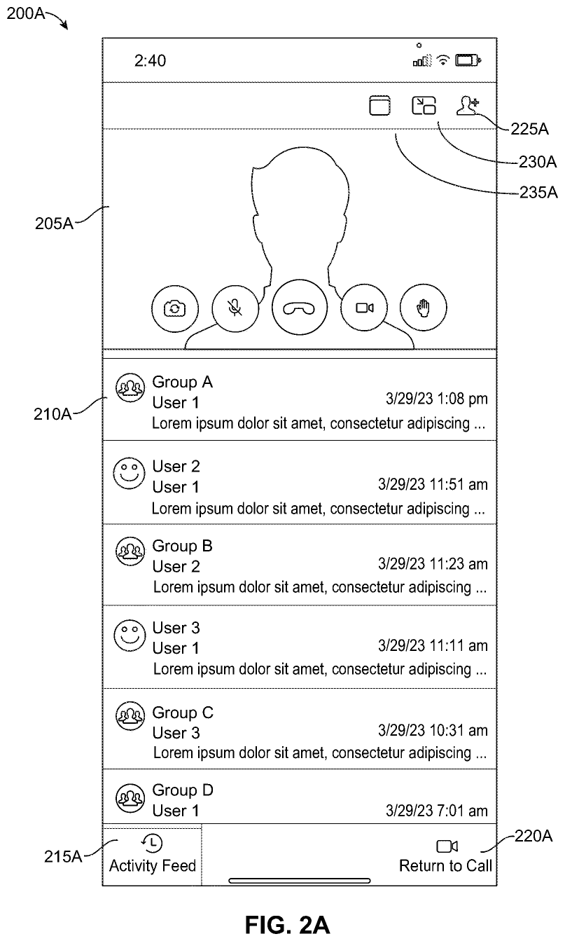

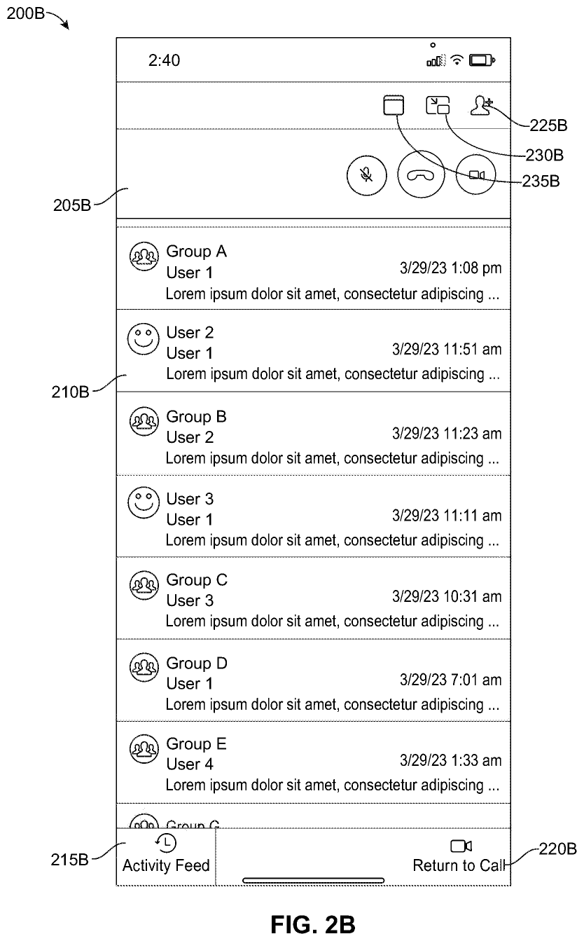

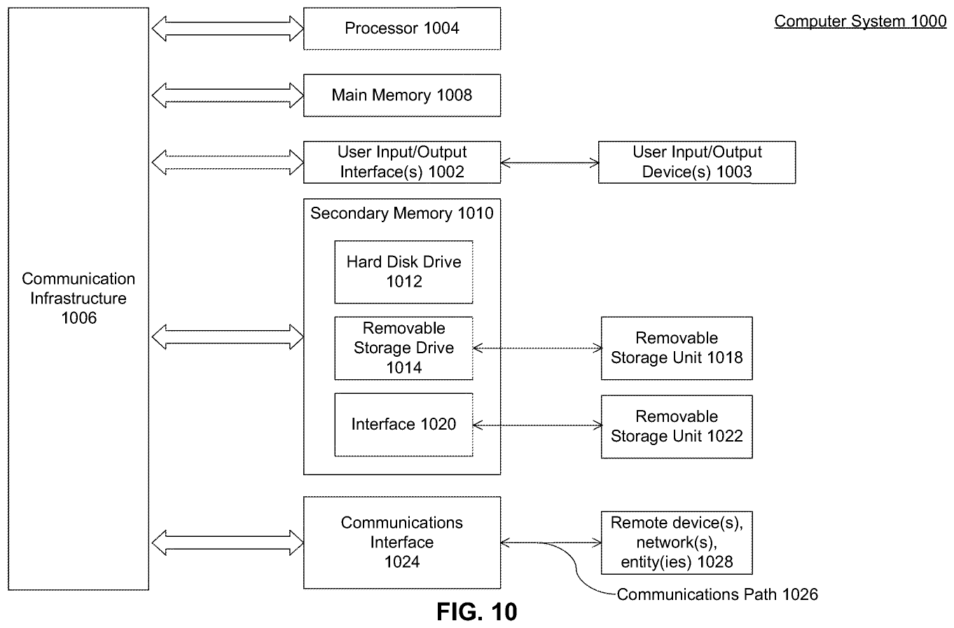

Messaging system 110 may be a computer system such computer system 1000 described with reference to FIG. 10. Messaging system 110 may be implemented using Internet-based components For example, messaging system 110 may be implemented using one or more servers and/or databases. Messaging system 110 may facilitate communications between mobile devices 130 and/or desktop devices 140. For example, messaging system 110 may facilitate video conferences, chat channels, and/or GUIs for communications. Examples of such GUIs are depicted in FIGS. 2A-2B, 3A-3B, 4-6, 7A-7B, and 8.

Messaging system 110 may generate workspaces, which may include one or more graphical user interfaces facilitating message exchanges. The workspaces may include chat panels, file management services, calendar services, meeting and/or video conferencing services, contact management, and/or other communication services. In some embodiments, to facilitate chat message communications, messaging system 110 may instantiate chat panels as well as provide an interface with user client devices, such as computers, laptops, or tablets for messaging.

For example, messaging system 110 includes messaging service 112. Messaging service 114 may facilitate chat channel communications. Chat channels may be used by individual users and/or by groups of users. For example, the chat channels may correspond to direct messages, team group messaging, division group messaging and/or other hierarchical communication structures. To facilitate communications within these chat channels, messaging system 110 may generate chat panels. These chat panels may be displayed on graphical user interfaces and/or generated by mobile GUI service 114.

When facilitating communications via chat panels, the messaging system 110 may transmit messages to users subscribed to a particular chat panel. For example, a user subscribed to a particular chat panel may utilize a mobile device 130 or desktop device 140 to deliver a message to other subscribed users. An administrator may also use mobile device 130 or desktop device 140 to interact with chat panels. A mobile device 130 may be an electronic device with messaging capabilities, such as, for example, a telephone, tablet, computer, laptop, or other smart devices. Desktop device 140 may include physical and/or stationary workspaces. Mobile device 130 or desktop device 140 may display a graphical user interface for the user to utilize when receiving or delivering messages. The user may use mobile device 130 or desktop device 140 to connect to messaging system 110, which may be configured to instantiate the chat panel. In some embodiments, messaging system 110 instantiates multiple chat panels, allowing many users to subscribe to one or more chat panels. In some embodiments, messaging system 110 is implemented in a web-based platform and client device 150 may use a computer communications protocol to connect to messaging system 110, such as, for example, WebSocket®, HTTP, or BOSH. In an embodiment, mobile device 130 may install a mobile application 132 to access the chat panels of messaging system 110.

Using the messaging servers and/or databases, messaging system 110 may facilitate messages exchanged between users using messaging service 112. Messaging service 112 may maintain chat channels, chat panels, and/or groups of conversations between users of messaging system 110. The chat panels may correspond to messages passed between two individuals and/or between more individuals. Messaging service 112 may facilitate instant messaging and/or real-time messaging between users and client devices.

Messaging system 110 also includes video conference service 114. Video conference service 114 facilitates video conferences between participants. For example, participants may use mobile devices 130 and/or desktop devices 140 to join a video conference. Messaging system 110 may also facilitate chat communications for the participants of the video conference. For example, messaging system 110 may generate a chat channel for the video conference. In some embodiments, a chat channel may already exist. A user may then initiate a video conference with members of the chat channel using messaging system 110.

When communicating on a mobile device 130, mobile application 132 may communication with mobile GUI service 116. Mobile GUI service 116 may generate one or more GUI screens to facilitate communications and/or navigations to different aspects of messaging system 110. This may include, for example, presenting the video conference stream, browsing of chat channels, facilitating chat communications with the video conference chat channel, facilitating chat communications with other chat channels, and/or file management. Examples of GUI screens generated by mobile GUI service 116 are further described with reference to FIGS. 2A-2B, 3A-3B, 4-6, 7A-7B, and 8. Mobile GUI service 116 may allow for streamlined navigation and access to the communications and filing sharing facilitated by messaging system 110.

In some embodiments, messaging system 110 may also store and/or manage files. For example, these files may be stored in messaging database 118. Messaging database 118 may also facilitate the storage and/or sharing of these files in chat panels. In some embodiments, mobile devices 130 and/or desktop devices 140 may upload files and/or data from a local system for sharing. Messaging system 110 may facilitate the uploading of a file by the mobile devices 130 and/or desktop devices 140 and/or interface with messaging service 112 to share the uploaded file in a chat panel.

Messaging system 110 may communicate with mobile devices 130 and/or desktop devices 140 via network 120. Network 120 may include any combination of wired and/or wireless networks, which may include mobile communication networks, Local Area Networks (LANs), Wide Area Networks (WANs), and/or the Internet. Messaging system 110 may use a communication interface to perform this communication. The communication interface may interface with these networks to implement bidirectional communications with one or more mobile devices 130 and/or desktop devices 140.

FIG. 2A depicts a block diagram of a graphical user interface (GUI) 200A displaying a video conference stream 205A and a list of chat channels 210A, according to some embodiments. GUI 200A may be generated by messaging system 110 and/or displayed using mobile device 130. Mobile application 132 may receive GUI data from messaging system 110 to construct and/or display GUI 200A.

The video conference stream 205A may be video received from other participants on a video conference. In some embodiments, the video conference stream 205A may include views of one or more participants. The views may be selectable and/or may be arranged in different layouts. These layouts may include highlighting the speaker, pinning a specific participant, displaying speakers in a grid, and/or other configurations. The video conference stream 205A may also show an image of the user. Video conference stream 205A may also include buttons including a camera rotate button, a mute button, a hang-up button, a stop/start video button, and/or a hand raise button.

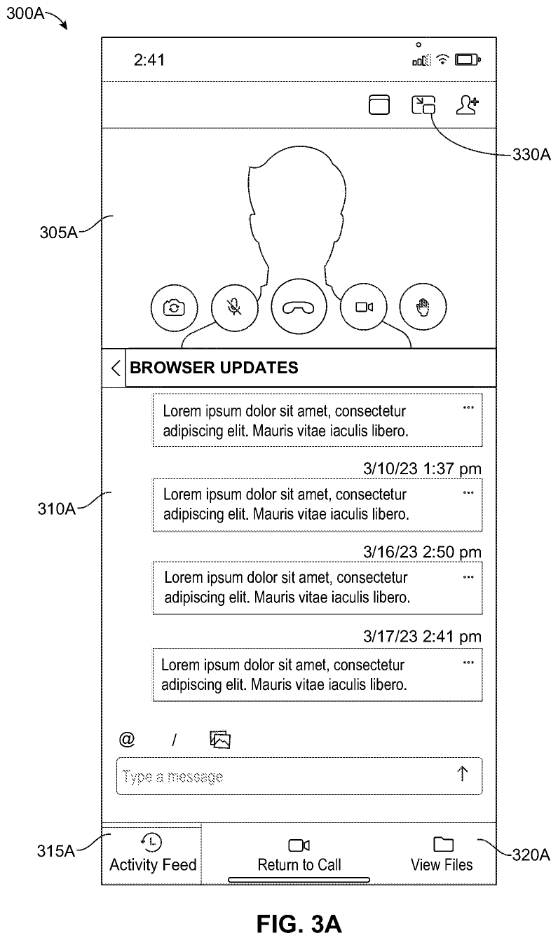

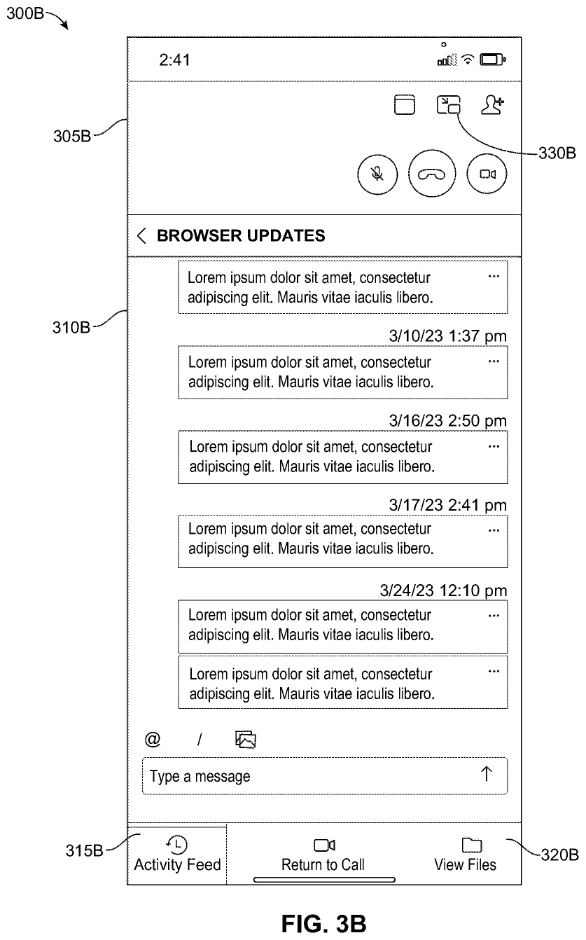

GUI 200A also includes a list of chat channels 210A and an activity feed button 215A. When a user selects activity feed button 215A, GUI 200A may display the list of chat channels 210A. The list of chat channels 210A corresponds to various chat channels where the user is a subscriber. This may include individual direct messages and/or group messages. When a user selects a chat channel, the mobile application 132 may retrieve the chat messages corresponding to the selected chat channel and may display those messages to the user in a chat panel. The user may also send messages to the other subscribers of that chat channel. Upon selecting a chat channel, GUI 300A as described with reference to FIG. 3A may be displayed.

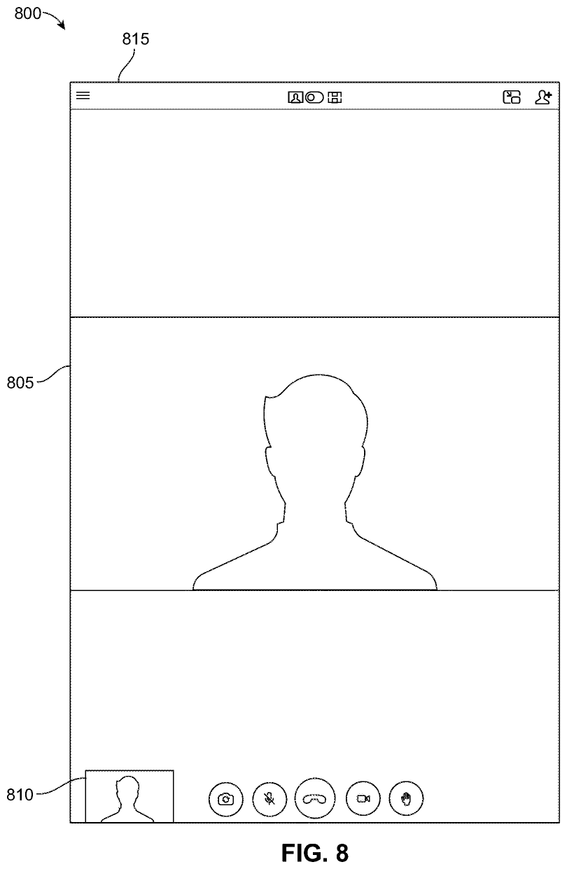

GUI 200A also includes a return button 220A. Selecting return button 220A may minimize list of chat channels 210A. This may expand video conference stream 205A such that it covers more of the mobile device screen. For example, video conference stream 205A may be expanded as depicted in GUI 800 as described with reference to FIG. 8.

GUI 200A may also include a menu of additional operations. For example, GUI 200A may include a full-screen button 235A. Selecting this button may cause video conference stream 205A to expand to cover the full-screen. GUI 200A may also include a minimize button 230A. Selecting the minimize button 230A may minimize video conference stream 205A. This may expand the list of chat channels 210A. An example of this is depicted as GUI 200B in FIG. 2B. In some embodiments, this may be considered an audio-only version of joining a conference. GUI 200A may include an add user button 225A. In response to selecting this button, messaging system 110 may update GUI 200A to include an interface for the user to identify a user to add to the video conference. This may include a list of user accounts and/or may allow a user to enter a user identification to add the user.

FIG. 2B depicts a block diagram of a graphical user interface (GUI) displaying a minimized video conference stream 205B and a list of chat channels 210B, according to some embodiments. GUI 200B may be generated by messaging system 110 and/or displayed using mobile device 130. Mobile application 132 may receive GUI data from messaging system 110 to construct and/or display GUI 200B.

GUI 200B may be displayed in response to a user selecting minimize button 230A as described with reference to GUI 200A. In this case, the video conference stream 205B portion of the GUI may be minimized. This may allow for additional browsing of the list of chat channels 210B. For example, the list of chat channels 210B will occupy more space on GUI 200B relative to the space occupied on GUI 200A. GUI 200B may also include an activity feed button 215B, return button 220B, add user button 225A, minimize button 230B, and/or full-screen button 235B. These may be similar to the corresponding buttons from GUI 200A.

FIG. 3A depicts a block diagram of a graphical user interface (GUI) 300A displaying a video conference stream 305A and a chat panel 310A, according to some embodiments. GUI 300A may be generated by messaging system 110 and/or displayed using mobile device 130. Mobile application 132 may receive GUI data from messaging system 110 to construct and/or display GUI 300A.

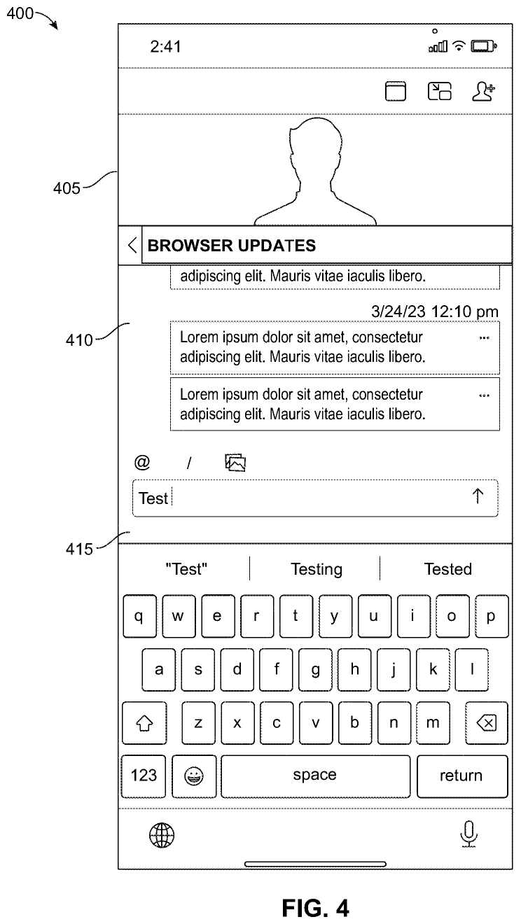

Video conference stream 305A may be similar to video conference stream 205A as described with reference to FIG. 2A. When a user selects a particular chat channel from the list of chat channels 210A and/or 210B, GUI 300A may be displayed with chat panel 310A. Chat panel 310A depicts chat messages exchanged with subscribers to the corresponding chat channel. Chat panel 310A also includes an area for the user to send a message and/or to send files as further described below. An example of this messaging is depicted and discussed with reference to FIG. 4 and GUI 400. GUI 300A may also include an activity feed button 315A. Selecting this button may return the user to the list of chat channels 210A and/or 210B.

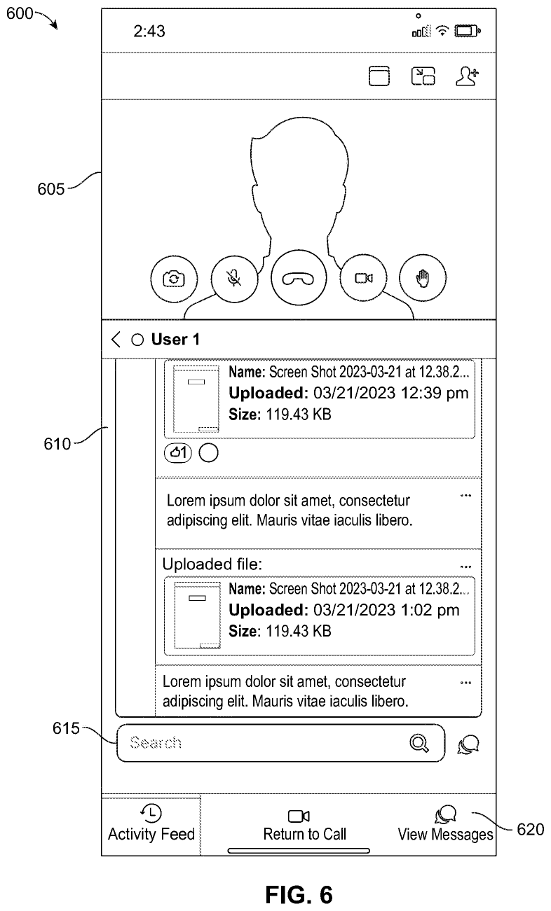

GUI 300A may also include a view files button 320A. Upon selecting the view files button 320A, a user may view the files that were shared within the particular chat channel selected. An example of this view is depicted with GUI 600 as described with reference to FIG. 6. In some embodiments, selecting view files button 320A may also allow a user to search for files in the select chat channel and/or across multiple chat channels. Messaging system 110 may provide an additional interface for the user to enter a keyword. Messaging system 110 may then identify one or more messages and/or files corresponding to the search term. Messaging system 110 may then display an identification of the messages and/or files.

GUI 300A may also include a minimize button 330A. This may be similar to minimize button 230A. When a user selects minimize button 330A, messaging system 110 may generate GUI 300B as described with reference to FIG. 3B.

FIG. 3B depicts a block diagram of a graphical user interface (GUI) 300B displaying a minimized video conference stream 305B and a chat panel 310B, according to some embodiments. GUI 300B may be generated by messaging system 110 and/or displayed using mobile device 130. Mobile application 132 may receive GUI data from messaging system 110 to construct and/or display GUI 300B.

GUI 300B may be displayed in response to a user selecting minimize button 330A as described with reference to GUI 300A. In this case, the video conference stream 305B portion of the GUI may be minimized. This may allow for chat panel 310B to be expanded to cover more of the area of the GUI. In this manner and using GUI 300B, a user may view more chat messages relative to the space occupied in GUI 300A. This may provide a more comfortable browsing experience for the user. GUI 300B may also include an activity feed button 315B, view files button 320B, and/or minimize button 330B. These may be similar to the corresponding buttons from GUI 300A.

FIG. 4 depicts a block diagram of a graphical user interface (GUI) 400 displaying a video conference stream 405 and text entry object 415 in a chat panel 410, according to some embodiments. GUI 400 may be generated by messaging system 110 and/or displayed using mobile device 130. Mobile application 132 may receive GUI data from messaging system 110 to construct and/or display GUI 400.

GUI 400 may be generated in response to a user selecting a particular chat channel and/or selecting a text bar within a chat panel 410 to input text. In response to selecting the text bar, GUI 400 displays the text entry object 415. This may display a virtual keyboard for the user to enter a message to send to other subscribers of the chat channel. When sending this message, this may be a message to chat channels that differ from the one where the user is currently participating in a video conference. For example, video conference stream 405 may correspond to a first chat channel. The chat panel 410, however, may correspond to a second chat channel. The user may have selected this second chat channel from the list as described with reference to GUIs 200A, 200B. In this manner, the user may participate in a video conference while chatting and/or reviewing messages from other chat channels.

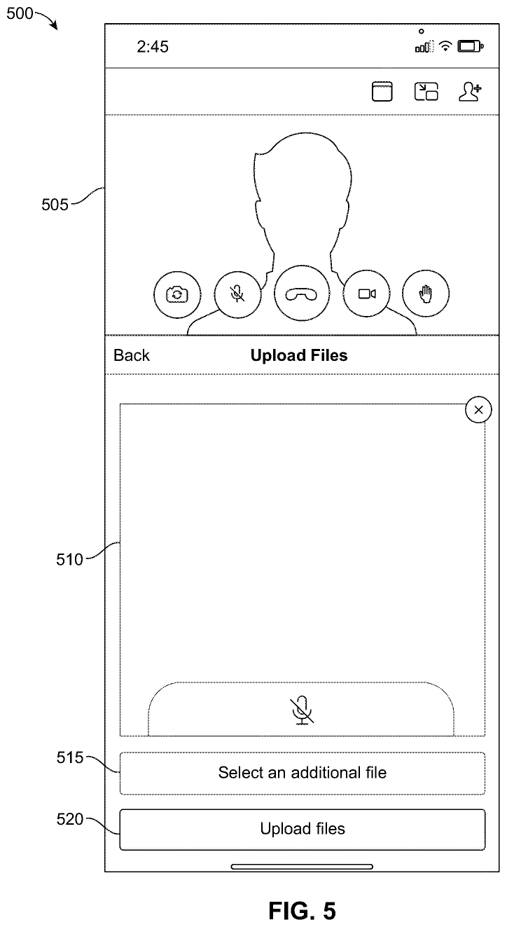

FIG. 5 depicts a block diagram of a graphical user interface (GUI) 500 displaying a video conference stream 505 and a file upload interface 510, according to some embodiments. GUI 500 may be generated by messaging system 110 and/or displayed using mobile device 130. Mobile application 132 may receive GUI data from messaging system 110 to construct and/or display GUI 500.

GUI 500 may be displayed in response to a user accessing a chat channel and/or accessing a text entry object as described with reference to FIG. 4 and GUI 400. For example, text entry object 415 may include an upload button allowing a user to upload a file to that chat channel. The chat channel may correspond to the video conference stream 505 where the user participating and/or may corresponding to a different chat channel as described with reference to FIG. 4. In this manner, the user may upload and/or share files from mobile device 130 to one or more chat channels while still participating in a video conference.

To share the file, GUI 500 may display a file upload interface 510. The file upload interface may include one or more icons and/or text identifying files stored locally on mobile device 130. The user may select a file to upload. In some embodiments, GUI 500 may include an additional files button 515. Selecting this button may allow a user to select multiple files for uploading. GUI 500 may also include an upload button 520. Selecting this button may upload the selected files to the chat panel. When uploading the files, mobile device 130 may transmit the file data to messaging system 110. Messaging system 110 may store the file data in messaging database 118 and/or transmit the file to other subscribers of the chat channel.

FIG. 6 depicts a block diagram of a graphical user interface (GUI) 600 displaying a video conference stream 605 and a file searching interface 610, according to some embodiments. GUI 600 may be generated by messaging system 110 and/or displayed using mobile device 130. Mobile application 132 may receive GUI data from messaging system 110 to construct and/or display GUI 600.

GUI 600 may be displayed in response to a user selecting a view files button 320A, 320B as described with reference to FIGS. 3A-3B. As previously explained, in some embodiments, the selection of this button may provide a list of files and/or messages within a particular chat panel or chat channel. This list of files and/or messages may be displayed in file searching interface 610. In some embodiments, GUI 600 may include a search bar 615. The search bar 615 may allow a user to enter a keyword and/or a search term to identify a message or file. This identification may identify files and/or messages within the particular chat channel selected and/or across multiple chat channels. For example, the search may search chat channels where the user is a subscriber. Upon entering the search term, mobile application 132 may transmit the search term to messaging system 110. Messaging system 110 may return file identifiers and/or identifications of the chat channels where the files or messages may be found. These file identifiers and/or chat channel identifiers may be displayed in file searching interface 610.

When browsing files displayed in file searching interface 610, a user may wish to share the file to another chat channel. This may be to share the file with the chat channel corresponding to video conference stream 605 and/or to share the file with a different chat channel. To share a file, the user may select and/or interact with a file in file searching interface 610. After receiving this interaction, GUI 600 may display an additional interface allowing a user to select a share button. After selecting the share button, the user may select a chat channel for sharing the file. For example, the user may select from a list of chat channels. The user may also select the chat channel corresponding to video conference stream 605. Upon receiving this selection, mobile application 132 may transmit a command to messaging system 110 to transmit the file to the selected chat channel. In some embodiments, messaging system 110 may retrieve the file from messaging database 118 and transmit the file to subscribers of the selected chat channel.

When the user has completed the review of the files and/or the file sharing process, the user may select view messages button 620 to return to a previous chat panel. For example, this may return to a display such as GUI 300A or 300B.

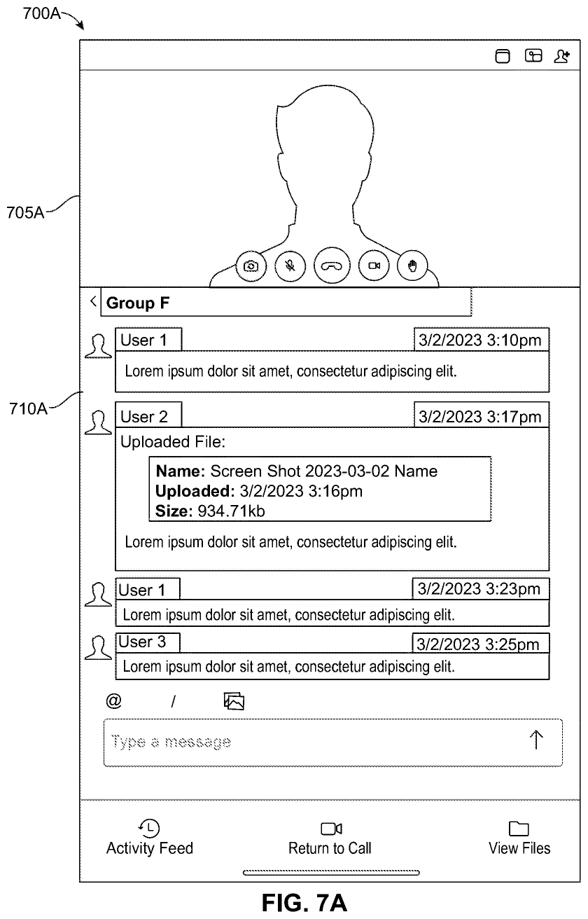

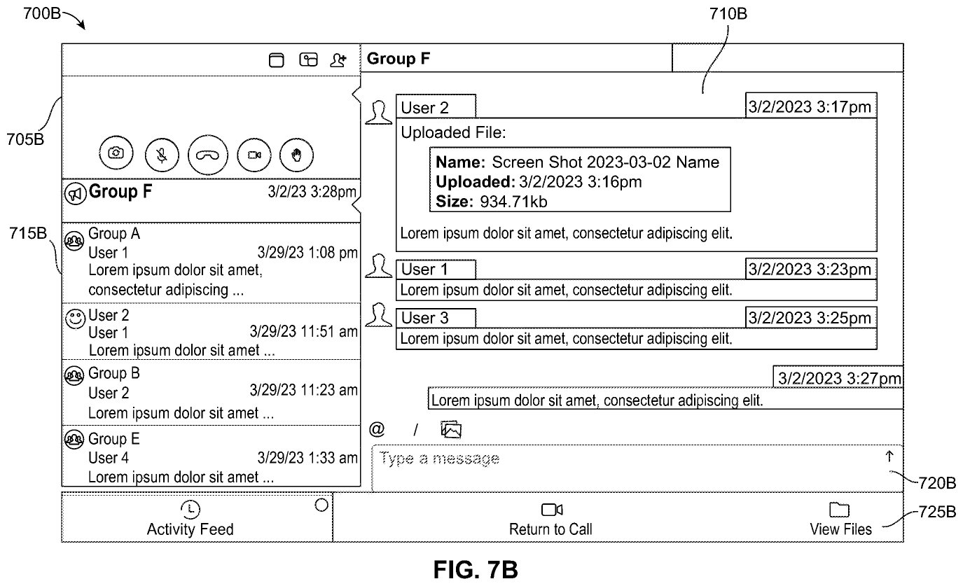

FIG. 7A depicts a block diagram of a graphical user interface (GUI) 700A displaying a video conference stream 705A and a chat panel 710A with a vertical orientation, according to some embodiments. GUI 700A may be generated by messaging system 110 and/or displayed using mobile device 130. Mobile application 132 may receive GUI data from messaging system 110 to construct and/or display GUI 700A.

GUI 700A includes a video conference stream 705A and a chat panel 710A this may be similar to GUI 300A as described with reference to FIG. 3A. The chat panel 710A in GUI 700A, however, may correspond to the video conference stream 705A. That is, participants of the video conference may view, transmit, and/or receive messages from the chat channel corresponding to chat panel 710A. In some embodiments, the orientation of GUI 700A may be vertical relative to the more horizontal orientation depicted in FIG. 7B and with GUI 700B. In some embodiments, the rotation of a mobile device may correspond to a rotation in orientation and may shift the display between GUI 700A and GUI 700B.

FIG. 7B depicts a block diagram of a graphical user interface (GUI) 700B displaying a video conference stream 705B, a chat panel 710B, and a list of chat channels 715B with a horizontal orientation, according to some embodiments. GUI 700B may be generated by messaging system 110 and/or displayed using mobile device 130. Mobile application 132 may receive GUI data from messaging system 110 to construct and/or display GUI 700B.

GUI 700B includes a video conference stream 705B and a chat panel 710B this may be similar to GUI 700A as described with reference to FIG. 7A. GUI 700B may also include a list of chat channels 715B. This list may be similar to the list 210A, 210B as described with reference to GUIs 200A, 200B. In this manner, GUI 700B may depict the video conference stream 705B, a chat panel 710B, and the list of chat channels 715B simultaneously. This may allow a user to quickly browse and/or review messages while participating on a video conference. The user may navigate between a chat channel corresponding to the video conference as well as other chat channels to review, receive, and/or transmit messages.

GUI 700B may also include a text entry object 720B. Text entry object 720B may be similar to text entry object 415 as described with reference to FIG. 4. Text entry object 720B may also allow a user to upload a file. For example, in response to an interaction with an upload button on text entry object 720B, GUI 700B may be updated to display file upload interface 510 and/or the other elements of GUI 500. Using this interface, a user may upload files to the chat channel. This may be the chat channel corresponding to the video conference stream 705B and/or may be a different chat channel.

GUI 700B may also include a view files button 725B. This may be similar to the view files button 320A, 320B as described with reference to GUIs 300A and 300B. Upon selecting view files button 725B, an interface similar to GUI 600 may be displayed. Similar to GUI 600, a user may view and/or search for one or more files. This may be within the particular chat panel and/or across other chat panels. The user may then also share the file as previously discussed with reference to GUI 600.

In this manner, a user may simultaneously participate in a video conference while communicating with different chat channels and/or sharing files across the chat channels. This interface may be provided on a mobile device 130 which may have limited screen space. The GUIs and navigational tools allow the user to efficiently locate chat panels and/or files and to communicate accordingly.

FIG. 8 depicts a block diagram of a graphical user interface (GUI) 800 displaying a full-screen video conference stream 805, according to some embodiments. GUI 800 may be generated by messaging system 110 and/or displayed using mobile device 130. Mobile application 132 may receive GUI data from messaging system 110 to construct and/or display GUI 800.

Mobile device 130 may display GUI 800 when a list of channels and/or chat panels has been minimized. In some embodiments, GUI 800 may include a full-screen video conference stream 805 depicting video from other participants. GUI 800 may also include a self-video stream 810. This may display images and/or video captured from a camera on the mobile device 130. This may also be the video seen by other participants. If the user wishes to access the navigation features described with reference to the other GUIs, the user may select a menu button 815. The menu button 815 may reveal other buttons. For example, a button may allow the user to view a list of chat channels. Selecting this may return the user to GUI 200A as described with reference to FIG. 2A.

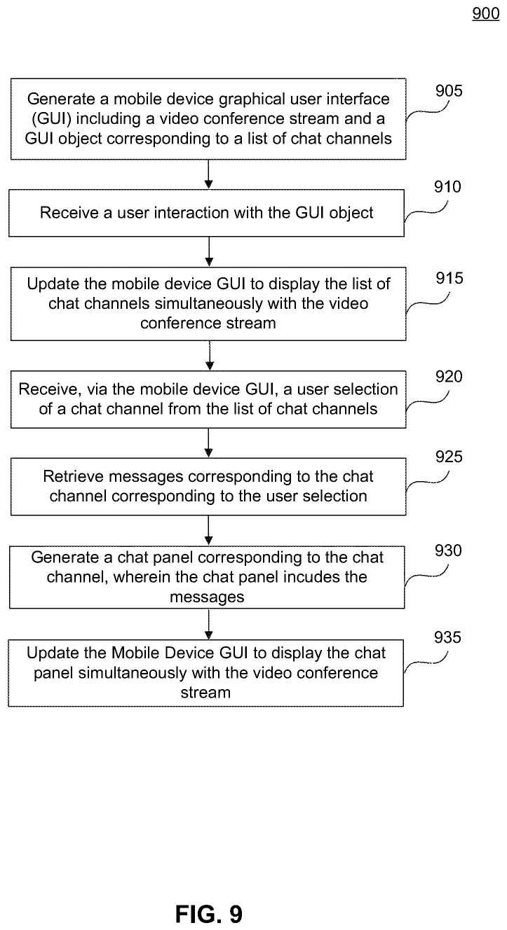

FIG. 9 depicts a flowchart illustrating a method 900 for simultaneously providing a video conference stream and a chat panel, according to some embodiments. Method 900 shall be described with reference to FIG. 1; however, method 900 is not limited to that example embodiment.

In an embodiment, messaging system 110 may utilize method 900 to generate a GUI for a mobile device 130 that simultaneously includes a video conference stream and a chat panel. The chat panel may correspond to a different chat channel than the video conference stream. The foregoing description will describe an embodiment of the execution of method 900 with respect to messaging system 110. While method 900 is described with reference to messaging system 110, method 900 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 9, as will be understood by a person of ordinary skill in the art.

At 905, messaging system 110 generates a mobile device graphical user interface (GUI) including a video conference stream and a GUI object corresponding to a list of chat channels. Messaging system 110 may transmit the mobile device GUI data to mobile device 130 for display. The mobile device GUI may be similar to GUI 800 as described with reference to FIG. 8. For example, the video conference stream may include video from different participants. The GUI object may be a menu button and/or other buttons that allow a user to request a view of a list of chat channels. These may be chat channels where the user is a subscriber. Messaging system 110 may identify these chat channels based on the user's account as managed by messaging system 110.

At 910, messaging system 110 receives a user interaction with the GUI object. For example, the user may interact with the GUI object as displayed on the mobile device 130. The mobile device 130 may then transmit an indication that the GUI object has been selected to messaging system 110.

At 915, messaging system 110 updates the mobile device GUI to display the list of chat channels simultaneously with the video conference stream. This may be similar to the GUIs 200A, 200B, and/or 700B as described with reference to FIGS. 2A-2B and/or 7B. In view of this interaction, mobile device 130 may display a mobile device GUI that includes the video conference stream along with a list of other chat channels for the user to peruse. The user is able to browse and/or interact with these other chat channels using mobile device 130 while still participating in the video conference.

At 920, messaging system 110 receives, via the mobile device GUI, a user selection of a chat channel from the list of chat channel. This selection may indicate the user's desire to view, send, and/or receive messages corresponding to that chat channel.

At 925, messaging system 110 retrieves messages corresponding to the chat channel corresponding to the user selection. For example, messaging system 110 may retrieve these messages from messaging database 118. In some embodiments, messaging system 110 may also retrieve one or more files that were shared in the chat channels.

At 930, messaging system 110 generates a chat panel corresponding to the chat channel. The chat panel includes the messages retrieved by messaging system 110. This may prepare and/or assemble the messages in a way that will be presented on the mobile device 130. For example, the messages may be organized in a chronological order.

At 935, messaging system 110 updates the mobile device GUI to display the chat panel simultaneously with the video conference stream. For example, messaging system 110 may transmit GUI control data to the mobile device 130. The mobile device 130 may then assemble the GUIs for display with the simultaneous display of the video conference stream and the chat panel. This may be similar to the GUIs 300A, 300B, 400, 700A, and/or 700B as described with reference to FIGS. 3A-3B, 4, and/or 7A-7B.

A user may subsequently send and receive messages via the chat panel as previously discussed. The user may also search for, upload, and/or share files as previously discussed as well. For example, this was described with reference to FIGS. 5-6 and GUIs 500 and 600.

Various embodiments may be implemented, for example, using one or more well-known computer systems, such as computer system 1000 shown in FIG. 10. One or more computer systems 1000 may be used, for example, to implement any of the embodiments discussed herein, as well as combinations and sub-combinations thereof.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
generating a mobile device graphical user interface (GUI) including a video conference stream and a GUI object corresponding to a list of chat channels;
receiving a user interaction with the GUI object;
updating the mobile device GUI to display the list of chat channels simultaneously with the video conference stream;
receiving, via the mobile device GUI, a user selection of a chat channel from the list of chat channels;
retrieving messages corresponding to the chat channel corresponding to the user selection;
generating a chat panel corresponding to the chat channel, wherein the chat panel includes the messages; and
updating the mobile device GUI to display the chat panel simultaneously with the video conference stream.

2. The computer implemented method of claim 1, further comprising:
updating the mobile device GUI to display the video conference stream, the list of chat channels, and the chat panel simultaneously.

3. The computer implemented method of claim 1, further comprising:
receiving, via the mobile device GUI, a search term in a search bar;
identifying one or more chat channel, wherein the one or more chat channels include a message having a file corresponding to the search term; and
updating the mobile device GUI to include identification corresponding to the one or more chat channels.

4. The computer implemented method of claim 1, further comprising:
receiving a selection of a file within the chat panel;
in response to receiving the selection of the file, transmitting a message including the file to one or more users participating in the video conference stream.

5. The computer implemented method of claim 1, further comprising:
receiving a selection of a file within the chat panel;
in response to receiving the selection of the file, transmitting a message including the file to one or more users within the chat channel corresponding to the chat panel, the chat channel differing from another chat channel corresponding to the video conference stream.

6. The computer implemented method of claim 1, further comprising:
receiving, via the mobile device GUI, a selection of at least one of a full-screen button, a minimize button, an activity feed button, or a return button;
in response to receiving the button selection, updating the mobile device GUI to expand or minimize the video conference stream relative to at least one of the list of chat channels or the chat panel.

7. The computer implemented method of claim 1, further comprising:
receiving, via the mobile device GUI, a selection of an add user button;
in response to receiving the button selection, updating the mobile device GUI to display an add user interface to receive an identification of a user to add to the video conference stream.

8. A system, comprising:
a video conference service configured to facilitate a video conference stream between a plurality of users;
a messaging service configured to facilitate chat channel communications;
a messaging database configured to store a plurality of files; and
a mobile GUI service configured to:
generate a mobile device GUI including the video conference stream and a GUI object corresponding to a list of chat channels;
receive a user interaction with the GUI object;
update the mobile device GUI to display the list of chat channels simultaneously with the video conference stream;
receive, via the mobile device GUI, a user selection of a chat channel from the list of chat channels;
retrieve messages corresponding to the chat channel corresponding to the user selection;
generate a chat panel corresponding to the chat channel, wherein the chat panel includes the messages; and
update the mobile device GUI to display the chat panel simultaneously with the video conference stream.

9. The system of claim 8, the mobile GUI service further configured to:
update the mobile device GUI to display the video conference stream, the list of chat channels, and the chat panel simultaneously.

10. The system of claim 8, the mobile GUI service further configured to:
receive, via the mobile device GUI, a search term in a search bar;
identify one or more chat channel, wherein the one or more chat channels include a message having a file corresponding to the search term; and
update the mobile device GUI to include identification corresponding to the one or more chat channels.

11. The system of claim 8, the mobile GUI service further configured to:
receive a selection of a file within the chat panel;
in response to receiving the selection of the file, transmit a message including the file to one or more users participating in the video conference stream.

12. The system of claim 8, the mobile GUI service further configured to:
receive a selection of a file within the chat panel;
in response to receiving the selection of the file, transmit a message including the file to one or more users within the chat channel corresponding to the chat panel, the chat channel differing from another chat channel corresponding to the video conference stream.

13. The system of claim 8, the mobile GUI service further configured to:
receive, via the mobile device GUI, a selection of at least one of a full-screen button, a minimize button, an activity feed button, or a return button;
in response to receiving the button selection, update the mobile device GUI to expand or minimize the video conference stream relative to at least one of the list of chat channels or the chat panel.

14. The system of claim 8, the mobile GUI service further configured to:
receive, via the mobile device GUI, a selection of an add user button;
in response to receiving the button selection, update the mobile device GUI to display an add user interface to receive an identification of a user to add to the video conference stream.

15. A non-transitory computer-readable device having instructions stored thereon that, when executed by at least one computing device, causes the at least one computing device to perform operations comprising:
generating a mobile device graphical user interface (GUI) including a video conference stream and a GUI object corresponding to a list of chat channels;
receiving a user interaction with the GUI object;
updating the mobile device GUI to display the list of chat channels simultaneously with the video conference stream;
receiving, via the mobile device GUI, a user selection of a chat channel from the list of chat channels;
retrieving messages corresponding to the chat channel corresponding to the user selection;
generating a chat panel corresponding to the chat channel, wherein the chat panel includes the messages; and
updating the mobile device GUI to display the chat panel simultaneously with the video conference stream.

16. The non-transitory computer-readable device of claim 15, the operations further comprising:
updating the mobile device GUI to display the video conference stream, the list of chat channels, and the chat panel simultaneously.

17. The non-transitory computer-readable device of claim 15, the operations further comprising:
receiving, via the mobile device GUI, a search term in a search bar;
identifying one or more chat channel, wherein the one or more chat channels include a message having a file corresponding to the search term; and
updating the mobile device GUI to include identification corresponding to the one or more chat channels.

18. The non-transitory computer-readable device of claim 15, the operations further comprising:
receiving a selection of a file within the chat panel;
in response to receiving the selection of the file, transmitting a message including the file to one or more users participating in the video conference stream.

19. The non-transitory computer-readable device of claim 15, the operations further comprising:
receiving a selection of a file within the chat panel;
in response to receiving the selection of the file, transmitting a message including the file to one or more users within the chat channel corresponding to the chat panel, the chat channel differing from another chat channel corresponding to the video conference stream.

20. The non-transitory computer-readable device of claim 15, the operations further comprising:
receiving, via the mobile device GUI, a selection of at least one of a full-screen button, a minimize button, an activity feed button, or a return button;
in response to receiving the button selection, updating the mobile device GUI to expand or minimize the video conference stream relative to at least one of the list of chat channels or the chat panel.
